(19) United States
(12) Patent Application Publication
(10) Pub. No.: US 2003/0122654 A1
(43) Pub. Date: Jul. 3, 2003

(54) Process for detecting simultaneous transmissions from electronic tags

(75) Inventors: Richard Kalinowski, Carnoux en Provence (FR); Michel Latteux, Villeneuve d'Ascq (FR); David Simplot, Bourghelles (FR)

Correspondence Address: IP DEPARTMENT OF PIPER RUDNICK LLP, 3400 TWO LOGAN SQUARE, 18TH AND ARCH STREETS, PHILADELPHIA, PA, 19103, US

(73) Assignee: Tagsys S.A., La Penne-sur-Huveaune (FR)

(21) Appl. No.: 10/302,047

(22) Filed: Nov. 22, 2002

Related U.S. Application Data
(63) Continuation of application No. PCT/FR01/01524, filed on May 17, 2001.

(30) Foreign Application Priority Data
May 25, 2000 (FR) 00/06698

(51) Int. Cl. H04Q 5/22

(52) U.S. Cl. 340/10.1; 340/572.1

(57) ABSTRACT

In a contactless electronic tag identification system including a multiplicity of electronic tags associated with a query/read/write device, the electronic tags transmitting messages at instants selected randomly or pseudorandomly during an interval of time or beat, a process for detecting in the query/read/write device substantially simultaneous transmission of at least two electronic tags, including (a) transmitting at a beginning portion of each electronic tag message a signal sequence selected from a set of sequences, (b) recognizing upon receiving messages by the query/read/write device the received signal sequence at the beginning of each message, and (c) detecting substantially simultaneous transmission of at least two electronic tags if the recognized signal sequence does not correspond to one of the sequences of the set.

### RELATED APPLICATION

This is a continuation of International Application No. PCT/FR01/01524, with an international filing date of May 17, 2001, which is based on French Patent Application No. 00/06698, filed May 25, 2000.

### FIELD OF THE INVENTION

The invention pertains to the field of electronic tags which are affixed to products to identify them according to their attributes. The invention pertains more specifically to a process for detecting simultaneous transmissions of messages originating from at least two electronic tags to be identified.

### BACKGROUND

It is known to use bar codes which are printed on products to identify the products and which are read by an optical device when they pass through a store's checkout register. Reading the bar code enables querying a computer which provides, e.g., the product's price. The bar codes have certain limitations which are due essentially to the fact that they are fixed when they are printed and thus cannot be modified over the course of the product's life.

It has therefore now been proposed to replace the bar codes with so-called “electronic tags” which contain electronic circuits such as a memory capable of storing an n-bit binary code. This binary code is representative of the bar code, notably for indicating the type of product, but can also represent other information or attributes which might be modified over the life of the product. This assumes that the memory is rewritable for at least certain parts of the n-bit binary code. Thus, there can be a date of sale, an identification of the store that made the sale, duration of the guarantee, expiration date of the guarantee and the like.

A query/read/write device (abbreviated as “QRW device”) is used to query the tags. This device can operate in the manner of a bar code reader, i.e., it dialogues with a single electronic tag at a time, i.e., the one that is presented in its radiation space.

However, the query/read/write device is capable of simultaneously querying all of the electronic tags located in its radiation space such that these tags also respond simultaneously and cannot be individually identified.

To resolve these problems, it has been proposed to query the electronic tags according to various so-called “anti-collision processes” which enable management of the tags that respond simultaneously and thus are in a state of collision. These anti-collision processes are divided into two classes: deterministic and non-deterministic.

In the first class, a first approach is to query the electronic tags on the basis, e.g., of all or part of the product's identification code until a single tag responds to this code or code portion. This first approach can lead to a high number of queries since, for a code of n=64 bits, there are more than 10₁₉ possibilities.

A second approach consists of repeating to the QRW device that which it receives from the electronic tags on a bit by bit or block-of-bits by block-of-bits basis. The electronic tags which recognize the repeated bit or block of bits know that they were taken into account by the query device and continues alone to transmit another bit or block of bits. These operations are repeated until the selection of a single electronic tag occurs.

The deterministic processes assume that no two electronic tags have the same identification code which constitutes a notable limitation on use in the case in which there exists a high number of products of the same type, e.g., in a supermarket, because each article must be tagged differently to be recognized.

Moreover, these deterministic processes only identify the electronic tags which are presented at the beginning of the implementation of the process for a given set.

A tag which is new in relation to this set may not be taken into account and waits for the following cycle of the identification process. These deterministic processes are therefore not directly applicable to a continuous identification of products, e.g., products passing by on a conveyor belt.

In the non-deterministic processes, the electronic tags are equipped such that they transmit a message after an interval of time of random duration calculated from a departure point given by the QRW device. The electronic tag assumes that its message has been recognized if it receives an acknowledgment of receipt from the QRW device. In the absence of an acknowledgment of receipt, the unrecognized electronic tag transmits its message during the following query cycle after passage of a new interval of time of random duration.

In such a non-deterministic process, it is probable that multiple electronic tags will transmit simultaneously if their total number is markedly larger than the number of random durations provided in a cycle, which causes interference with the message from the electronic tag that was the first to transmit.

It was therefore proposed to silence the electronic tags upon detection of transmission by another tag. Such detection can be implemented by the electronic tags themselves or by the QRW device.

The performances of the non-deterministic processes are determined by the maximum number NsMAX of transmission interval windows during a cycle in relation to the number N of electronic tags. This number NsMAX also defines the number of possible random waiting times. Thus, in the case of N electronic tags, the process is optimal for a value Ns1 of NsMAX, but in the case of 2N electronic tags, the process is optimal for a value 2Ns1 of NsMAX. Consequently, the process is not suitable for all numbers of electronic tags.

In U.S. patent application Ser. No. 99/08181 filed on Jun. 25, 1999, there is described a process for adapting the number of random waiting periods or transmission windows to the number of electronic tags remaining to be identified. This adaptation is performed by the QRW device in relation to the identification results of the preceding cycle.

This electronic tag identification process comprises the following steps consisting of:

(a) indicating to the electronic tags the number Ns of consecutive transmission windows of a first cycle or round,

(b) counting, during the cycle of Ns windows, the messages received from the electronic tags for determining the number nᵢ of identifications, the number nᵥ, of windows or empty compartments and the number n_{c} of collisions,

(c) stopping the process if n_{c}=0 or advancing to step (d) if n_{c}≠0,

(d) calculating a number Ns1 of transmission windows for the following cycle as a function of the values of Ns, nᵢ, nᵥ and n_{c},

(e) returning to step (a) with Ns=Ns1 calculated.

In each electronic tag, the process furthermore comprises the following steps consisting of:

(m) receiving the number Ns of windows for each cycle or round,

(n) randomly selecting a transmission window among Ns,

(o) transmitting a message during the duration of the selected window,

(p) waiting for a message originating from the query/read/write device,

(q) receiving the acknowledgment of receipt transmitted by the query/read/write device in the absence of collision,

(r) returning to step (m) in the case of lack of acknowledgment of receipt, i.e., in the case of collision or empty window.

This identification process, referred to as adaptive rounds, considerably improves the efficacy of identification because it adapts as the tag recognition proceeds the ratio of the transmission times and silence by modifying the duration of the following round in terms of windows or slots contained in the round at the end of each round.

However, this identification process based on adaptive rounds leads to a duration of identification equal to at least Ns·d in which d is the duration of one window. But, among the Ns windows, certain of them are empty and others have at least one collision which reduces the temporal efficacy of the process.

The previously cited patent application therefore provides for advancing to the following window upon detection of an empty window or a window with a collision. Although it is easy to detect an empty window, it is more difficult to detect a window with a collision.

It would therefore be advantageous to provide a process for detecting simultaneous transmissions of messages originating from electronic tags, i.e., the detection of collisions.

### SUMMARY OF THE INVENTION

This invention relates to a contactless electronic tag identification system including a multiplicity of electronic tags associated with a query/read/write device, the electronic tags transmitting messages at instants selected randomly or pseudorandomly during an interval of time or beat, a process for detecting in the query/read/write device substantially simultaneous transmission of at least two electronic tags, including (a) transmitting at a beginning portion of each electronic tag message a signal sequence selected from a set of sequences, (b) recognizing upon receiving messages by the query/read/write device the received signal sequence at the beginning of each message, and (c) detecting substantially simultaneous transmission of at least two electronic tags if the recognized signal sequence does not correspond to one of the sequences of the set.

### BRIEF DESCRIPTION OF THE INVENTION

Other characteristics and advantages of the invention will become clear upon reading the description below of particular examples of implementation, said description being presented with reference to the attached drawings in which:

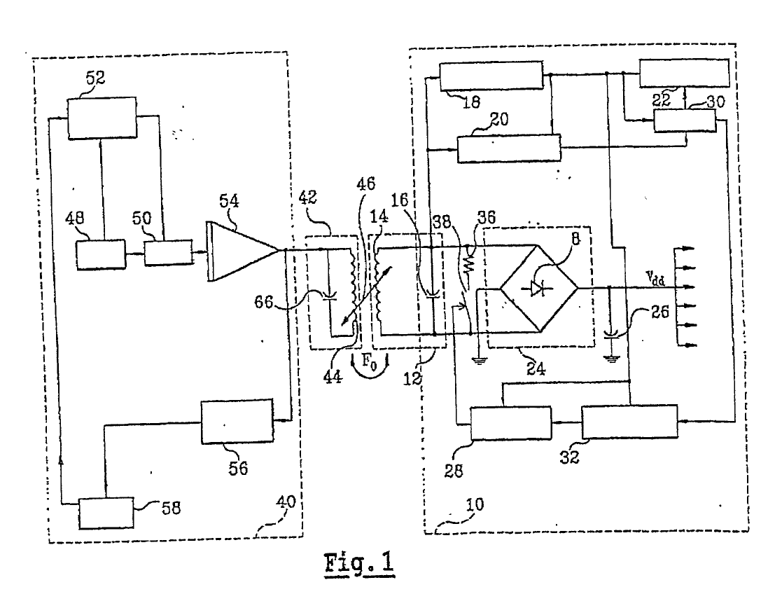

FIG. 1 is a functional diagram of a contactless electronic tag and a QRW device of such a tag to which the process according to the invention applies,

FIG. 2 is a diagram showing the composition of a message transmitted by an electronic tag implementing the process according to the invention,

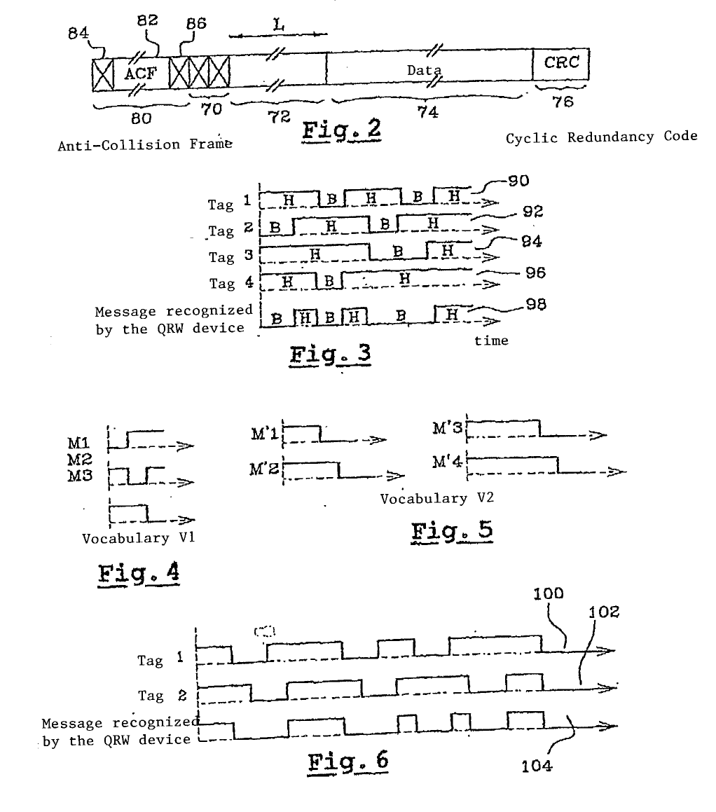

FIG. 3 is a diagram showing examples of anti-collision sequences or frames and the result of their superposition corresponding to a collision,

FIGS. 4 and 5 are diagrams showing sequences of symbols constituting words of a vocabulary which are combined so as to constitute a sequence or frame, and

FIG. 6 comprises diagrams showing sequences of words for constituting sequences or frames and the result of their superposition corresponding to a collision.

### DETAILED DESCRIPTION

The process of the invention comprising causing a message transmitted by each tag to be preceded by a group of signals having a particular format so that a QRW device can detect, as quickly as possible after the beginning of a window, substantially simultaneous transmission by multiple tags and, thus, detect the existence of collisions.

In the description below we assume that this group of signals is an integral part of the message transmitted by each tag and constitutes an anti-collision sequence or frame, referred to as “ACF” for the English-language acronym “Anti-Collision Frame,” and which is positioned at the beginning of the message.

The format of the ACF in each message is selected from a set of formats which is such that the superposition of ACFs originating from two or more simultaneous messages leads to a group of signals the format of which does not belong to the previously mentioned set.

The set of formats can comprise N different formats, each tag selecting one of the N formats in a random or pseudorandom manner upon each message transmission by a tag.

The ACF can be preceded by a particular signal such as a signal referred to as a “code-violation signal” indicating the start of the ACF to enable recognition of an ACF by the QRW device.

In a contactless electronic tag identification system comprising a multiplicity of electronic tags associated with a QRW device, the electronic tags transmitting messages at instants selected randomly or pseudorandomly during an interval of time or beat, the invention concerns a process for detecting in the QRW device simultaneous transmission of at least two electronic tags comprising:

(a) transmitting at the beginning of each electronic tag message a particular signal sequence (or frame) which is selected from a set of particular sequences,

(b) recognizing upon receiving the messages by the QRW device the received signal sequence at the beginning of each message, and

(c) detecting substantially simultaneous transmission of at least two electronic tags if the recognized signal sequence does not correspond to one of the particular sequences of the set.

According to another characteristic of the invention, the particular signal sequence is selected in a random manner from among the sequences of the set. This particular sequence can be composed randomly from a multiplicity of elementary sequences or words constituting a vocabulary. The number of words in a sequence can be fixed or selected randomly.

According to another characteristic of the invention, the particular signal sequence can be preceded by a start sequence signal of the code violation type, the signal not corresponding to any of the sequences of the set.

The particular signal sequence can be followed by an end sequence signal of the code violation type not corresponding to any of the sequences of the set nor to the start sequence signal if such exists.

The process for detecting simultaneous transmission of messages originating from electronic tags is applicable to a system as shown in FIG. 1 comprising a multiplicity of contactless electronic tags 10 associated with a QRW device 30.

The contactless electronic tag 10 comprises, e.g., an antenna 12 including a tuned circuit which comprises an induction coil 14 and a condenser 16. The tuning frequency F₀ of the antenna 12 is, e.g., 13.56 megahertz.

This tuned circuit of the antenna is connected to different circuits each of which performs a particular function. Thus, a circuit 24 performs the function of full-wave rectification of the signal at the terminals of the tuned circuit, e.g., by a diode bridge 8. This rectification circuit 24 is followed by a filtration condenser 26 of the rectified circuit which provides the feed voltage V_{dd} of the other circuits of the electronic tag, notably the circuits shown in rectangle 10 of FIG. 1.

Circuit 18 performs the clock function and synchronization of this function from frequency F₀. The signals at different frequencies provided by this clock circuit 18 are applied to the other circuits of the tag represented or not except the antenna 12 and the rectification circuit 24.

Circuit 20 performs the function of demodulation and decoding of the signals that modulate the carrier frequency signal F₀, signals that constitute the information received by the tag.

The information relative to the product with which the tag is associated are recorded in a memory 22 which can be addressed by a read/write circuit 30.

This read/write circuit 30 is under control of the signals detected and decoded by circuit 20 and provides signals which are applied to a message synthesis circuit 32.

The messages provided by the synthesis circuit 32 are applied to an antenna load modulation circuit which is represented schematically by a circuit 28 and a switch 38 controlled by circuit 28. A load resistance 36 is shown in series with the switch 38.

The QRW device of the tag 10 comprises, e.g., an antenna 42 including a tuned circuit which comprises an induction coil 44 and a condenser 66, the tuning frequency being F₀. The two antennas 12 and 42 are magnetically coupled as shown by arrow 46.

Antenna 42 is fed by electric signals at the carrier frequency F₀ which are modulated by the low-frequency digital signals carrying the information to be transmitted to the tag 10. These modulated electric signals are processed by a modulator 50 which receives, on the one hand, a signal at the frequency F₀ from an oscillator 48 and modulation signals from a message generator 52. The output signals from the modulator 50 are applied to a power amplifier 54 the output terminal of which is directly connected to the antenna 42.

The signals received by the antenna 42 are applied to a receiving circuit 56 which performs detection, demodulation and decoding. The decoded signals are applied to a microprocessor 58 which interprets them and provides the control signals of the message generator 52.

The identification system of the electronic tags can be either of the type in which the tags transmit a message as soon as they are powered up, or of the type in which they transmit a message after having received an order from the QRW device. In both types of operating, the message from the tags comprises, e.g. (FIG. 2):

a message start signal 70, constituted, e.g., by a particular series of binary numbers which indicates, for example, how the data are presented,

a time interval 72 the constant duration L of which is known by the query device,

a binary data message 74, and

an error correction code 76, more commonly known under the English-language acronym of CRC for “Cyclic Redundancy Check”.

According to the invention, this classic message of the tags of the prior art is preceded by a group of signals 80 which comprises principally an anti-collision sequence or frame (ACF). This frame 82 can be preceded by an ACF start signal (reference 84) which is, for example, constituted by a particular sequence of analog signals similar to that of the ACF. It is preferably followed by an ACF end signal (reference 86) similar to that of the ACF.

The composition of each ACF of a tag message is determined in a random or pseudorandom manner, for example, as a function of the information contained in the electronic tag. In the case of a random composition, none of the ACF sequences will be identical to another such that superposition according to a logical combination of two ACFs would not result in a possible ACF. This characteristic makes it possible to detect a collision in the QRW device. Thus, when the ACF is received a collision is detected when the ACF signals received do not correspond to a possible ACF.

In the case of a pseudorandom composition, there is a certain probability that the ACFs of two tags transmitting simultaneously could be identical but this probability is very weak. The composition of the ACFs can be performed in different manners in the electronic tags. Several examples are described below in relation to FIGS. 3, 4, 5 and 6.

First, as an example, use will only be made of frame signals having two symbols identified as “H” for a high signal and “B” for a low signal. The succession of these two symbols makes it possible to create an ACF and FIG. 3 shows the different ACFs 90, 92, 94 and 96 of four tags 1, 2, 3 and 4. When these tags transmit simultaneously, the signals of the fours ACFs received by the query device are superposed and their combination according to a certain logical rule yields the signals of the diagram 98.

This logical rule is, for example, that if at least one tag transmits a signal B, then the QRW device comprises the symbol B and it only comprises a symbol H if all of the tags transmit a symbol H. Diagram 98 is different from diagrams 90, 92, 94 and 96, and indicates that there are at least two tags transmitting simultaneously, i.e., that there is a collision.

It is possible to implement the process according to the invention using only the four compositions of FIG. 3, each tag selecting randomly at each transmission one of the four compositions. However, the probability will be high that two tags simultaneously transmit the same ACF. One of the solutions for decreasing this probability is to increase the number of possible compositions which leads to the augmentation of the size of the memory for recording them in the tag and a higher cost for the tag.

The invention therefore provides tools such that the composition of each frame is implemented from simple elements which are combined randomly to constitute a sequence or frame.

According to a first characteristic, the symbols H and B are alternated according to given lengths to constitute words such as those represented by the diagrams of FIGS. 4 and 5, each group of words constituting a vocabulary. Vocabulary V1 of FIG. 4 comprises three words M1, M2 and M3, each extending over three lengths of symbols, with the symbol B taking a different position in each word.

Vocabulary V2 of FIG. 5 comprises four words M′1, M′2, M′3 and M′4 each comprising two levels B at the end of each word preceded respectively by two, three, four and five levels H according to the word taken into consideration. These words are simple elements combined randomly in a sequence to compose an ACF.

FIG. 6 shows two ACFs composed for tag 1 (diagram 100) of the words M′1, M′3, M′1 and M′4 of vocabulary V2 and for tag 2 (diagram 102) of the words M′2, M′3, M′3 and M′1 of vocabulary V2. The superposition of these two ACFs by the QRW device according to the previously stated logical rule leads to the series of symbols of diagram 104, it only being possible to generate this series by some sequence of the words M′1, M′2, M′3 and M′4 of vocabulary V2. The result is that there are at least two tags in collision.

The example of FIG. 6 comprises four-word sequences. However, the sequences can be comprised of more than four words and their number can be fixed or determined randomly. Vocabularies other than V1 or V2 can be envisioned without departing from the framework of the invention. However, the words are selected in a manner such that two sequences of different words are not superposed to yield a sequence of possible words.

As stated above, the ACF can be preceded and/or followed by an ACF start and/or end signal, this signal preferably being of the code-violation type. In this case, the code violation is different from any of the random sequences or a superposition of random sequences.

In the case in which the lengths of the sequences are not fixed, the code-violation sequence 86 can be followed by a blank signal-free space, e.g., part 72, which has a determined duration L, such that if the duration of the blank is less than the provided duration L, the collision is detected.

This characteristic can be especially exploited in the case in which the clock signals of the electronic tags are not synchronized on the signals of the QRW device, i.e., in the case of an asynchronous system.

1. In a contactless electronic tag identification system comprising a multiplicity of electronic tags associated with a query/read/write device, said electronic tags transmitting messages at instants selected randomly or pseudorandomly during an interval of time or beat, a process for detecting in the query/read/write device substantially simultaneous transmission of at least two electronic tags, comprising:
(a) transmitting at a beginning portion of each electronic tag message a signal sequence selected from a set of sequences,
(b) recognizing upon receiving messages by the query/read/write device the received signal sequence at the beginning of each message, and
(c) detecting substantially simultaneous transmission of at least two electronic tags if the recognized signal sequence does not correspond to one of the sequences of the set.

2. The process according to claim 1, wherein the signal sequence in step (a) is selected in a random manner from among the sequences of the set.

3. The process according to claim 1, wherein the signal sequence in step (a) is composed in a random manner from a multiplicity of elementary sequences or words constituting a vocabulary.

4. The process according to claim 3, wherein the number of words of a sequence is fixed.

5. The process according to claim 3, wherein the number of words of a sequence is selected in a random manner.

6. The process according to claim 1, wherein step (c) comprises:
(c₁) comparing the sequence recognized in step (b) to each sequence of the set, and
(c₂) signaling the existence of a substantially simultaneous transmission if the comparison is negative.

7. The process according to claim 1, wherein step (c.) comprises:
(c′₁ ) comparing the sequence recognized in step (b) to each sequence of a second set of sequences resulting from logical combinations of the sequences of the set, and
(c′₂) signaling the existence of a substantially simultaneous transmission if the comparison is positive.

8. The process according to claim 1, wherein in step (a), the signal sequence is preceded by a code violation start sequence signal, the signal not corresponding to any of the sequences of the set.

9. The process according to claim 1, wherein in step (a), the signal sequence is followed by a code violation end sequence signal, the signal not corresponding to any of the sequences of the set nor to that of the start sequence.

10. The process according to claim 9, wherein the end sequence signal is followed by a time interval of substantially constant duration (L) without a transmission signal, and step (c) further comprises:
measuring the time interval,
signaling the existence of a substantially simultaneous transmission if the measured signal-free time interval is different than value (L).
